(19) United States
(12) Patent Application Publication
(10) Pub. No.: US 2024/0217106 A1
(43) Pub. Date: Jul. 4, 2024

(54) TEACH PENDANT, ROBOT SYSTEM AND ROBOT CONTROL DEVICE

(71) Applicant: FANUC CORPORATION, Minamitsuru-gun, Yamanashi (JP)

(72) Inventor: Kiyoshi YOSHINO, Minamitsuru-gun, Yamanashi (JP)

(21) Appl. No.: 18/567,459

(22) PCT Filed: Jul. 13, 2021
(86) PCT No.: PCT/JP2021/026348

§ 371 Date: Dec. 6, 2023

(51) Int. Cl. B25J 9/16; G05B 19/418

(52) U.S. Cl. CPC B25J 9/1674; G05B 19/4185; G05B 2219/31333

(57) ABSTRACT

The present invention makes it possible to reliably recover a state of software of a robot control device by storing a backup file of the robot control device without using an external storage device. A teach pendant according to the present invention comprises: a communication unit that receives a backup file of a robot control device which controls a robot; and a storage unit that stores the received backup file.

### TECHNICAL FIELD

The present invention relates to a teach pendant, a robot system, and a robot control device.

### BACKGROUND ART

Backups of robot control devices, which control robots such as industrial robots installed in factories and the like, are crucial systems that allow for restoration to their original normal state if programs, etc. are lost or the like due to malfunctions or incorrect operations of robot control devices.

Backing up a robot control device refers to the practice of saving information, such as motion programs of robots or settings of network communication, as an electronic file in a binary or text format (hereinafter also referred to as “backup file”). A backup file is an electronic file, and can therefore be copied to external storage devices, such as USB memory or file servers.

As a result, the state of the software of the robot control device can be restored from the backup file to the state when the backup was made.

Robot control devices for robots such as industrial robots have a teach pendant. The teach pendant has only a minimal capacity as a display/operating device which comes with the robot control device, and is equipped with only a small-scale storage device. Therefore, the teach pendant does not have a sufficient storage capacity to save the backup files of the robot control device.

In this regard, a technology has been known, in which a robot control device controls an automatic main wiring device as a robot located in a remote area such as an isolated island, and manages the control device data as backup data; a remote operation terminal device remotely operates the robot control device, and periodically collects the control device data; and if failure occurs in both sets of data stored in the main storage unit and the auxiliary storage unit provided in the robot control device, the remote operation terminal restores data by using the collected control device data. Refer to Patent Document 1 for example.

### CITATION LIST

### Patent Document

Patent Document 1: Japanese Unexamined Patent Application, Publication No. H10-29181

### DISCLOSURE OF THE INVENTION

### Problems to be Solved by the Invention

However, in the case of industrial robots and the like, the file size of the backup files may amount to several hundred megabytes in total.

Patent Document 1 manages the backup data of the robot control device that controls the automatic main wiring device located in the remote area, where a large backup file is difficult to manage.

Further, in regards to an external storage device that saves the backup files, in the case of post-purchase management of an external storage device or management after saving the backup files (such as measures against loss), if the correspondence relationship between the backup files and the robot control device becomes unrecognizable, the normal state will be difficult to restore; therefore, the copied electronic files should be managed (such as by managing which electronic file is the backup file acquired from which robot control device in the case of having a plurality of robot control devices).

As a possible method, the backup files may be saved in the robot control device itself, instead of using an external storage device; however, if the robot control device malfunctions, the saved backup files may no longer be usable, which is therefore an inadequate method of saving a backup.

In the case of using a plurality of backup files, it is necessary to keep managing what purpose each file was saved for. Otherwise, when restoring from a backup file, it will be difficult to recognize which backup file should be used.

Restoration from a backup file can also be time-consuming, and if the wrong backup file is used for restoration, restoration processes must be repeated, leading to a loss of time.

Therefore, introducing and managing large-capacity storage devices for backup files is indispensable; however, this involves the problem of monetary costs and continual management costs.

Therefore, there has been a desire for saving the backup files of the robot control device by introducing a large-capacity storage device, and allowing for easily managing the backup files, ensuring the restoration of the state of the software of the robot control device in the event of loss of programs, data, etc. due to failures or incorrect operations of the robot control device.

### Means for Solving the Problems

(1) One aspect of the teach pendant of the present disclosure includes a communication unit configured to receive a backup file of a robot control device that controls a robot, and a storage unit configured to save the backup file received.

(2) One aspect of the robot system of the present disclosure includes a robot control device that controls the robot and the teach pendant of (1).

(3) One aspect of the robot control device of the present disclosure includes the teach pendant of (1).

### Effects of the Invention

According to one aspect, a large-capacity storage device is introduced to save backup files of a robot control device, and the backup files can be easily managed, ensuring the restoration of the state of the software of the robot control device in the event of loss of programs, data, etc. due to failures or incorrect operations of the robot control device.

### BRIEF DESCRIPTION OF THE DRAWINGS

FIG. 1 is a diagram illustrating a configuration example of a robot system according to a first embodiment;

FIG. 2 is a functional block diagram illustrating a functional configuration example of a robot control device and a teach pendant according to the first embodiment;

FIG. 3 is a flowchart illustrating backup processing of the robot system;

FIG. 4 is a flowchart illustrating restoration processing of the robot system;

FIG. 5 is a diagram illustrating a configuration example of the robot system according to a second embodiment;

FIG. 6 is a functional block diagram illustrating a functional configuration example of the robot control device and the teach pendant according to the second embodiment;

FIG. 7 is a flowchart illustrating the backup processing of the robot system;

FIG. 8 is a flowchart illustrating the restoration processing of the robot system;

FIG. 9 is a flowchart illustrating the restoration processing of the robot system;

FIG. 10 is a functional block diagram illustrating a functional configuration example of the robot control device and the teach pendant according to a third embodiment;

FIG. 11 is a flowchart illustrating the restoration processing of the robot system; and

FIG. 12 is a flowchart illustrating the restoration processing of the robot system.

### PREFERRED MODE FOR CARRYING OUT THE INVENTION

Detailed descriptions will be provided for first to third embodiments by referring to the drawings.

Here, each embodiment shares a common configuration, in which a backup file of a robot control device is saved on a teach pendant.

However, in terms of saving a backup file, the teach pendant in the first embodiment is connected to one robot control device, only saves a backup file of the robot control device, and restores the state of the software of the robot control device by using the saved backup file. In contrast, in the second embodiment, the teach pendant can be connected to each of a plurality of robot control devices, saves backup files including individual numbers of the robot control devices, respectively, and uses a backup file corresponding to an individual number of a connected robot control device when restoring the state of the software of the connected robot control device, which differs from the first embodiment. In the third embodiment, a function to display a preview of a backup file is added to the first and second embodiments, when the teach pendant restores the state of the software of the robot control device from the backup file.

Hereinafter, detailed description on the first embodiment will be provided first, followed by description on the second and third embodiments, focusing on the points different from the first embodiment.

### FIRST EMBODIMENT

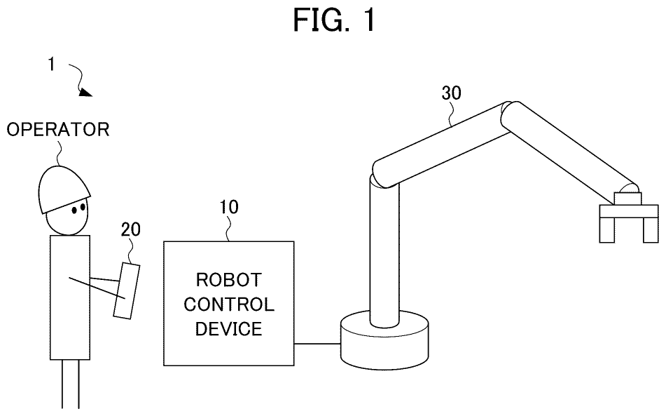

FIG. 1 is a diagram illustrating a configuration example of the robot system according to the first embodiment.

As illustrated in FIG. 1, the robot system 1 includes a robot control device 10, a teach pendant 20, and a robot 30.

The robot control device 10, the teach pendant 20, and the robot 30 may be directly connected to each other via a connection interface (not illustrated) in a wired or wireless manner. The robot control device 10, the teach pendant 20, and the robot 30 may be connected to each other via a network (not illustrated) such as a LAN (Local Area Network) or the Internet in a wired or wireless manner. In this case, the robot control device 10, the teach pendant 20, and the robot 30 include a communication unit (not illustrated) to communicate with each other via such connection.

### <Robot 30>

The robot 30 is a known robot that operates based on the control by the robot control device 10 (described later). The robot 30 includes a base part for rotation around the vertical axis, an arm that moves and rotates, and an end effector such as a hand attached to the arm.

### <Robot Control Device 10>

The robot control device 10 is a device for controlling the operation of the robot 30, and is known to those skilled in the art. For example, the robot control device 10 executes a motion program that is generated using the orthogonal coordinate values or each axis value indicating the position of the endpoint of the robot 30 as taught by the user who operates the teach pendant 20 (described later), thereby generating control signals, and outputting the generated control signals to the robot 30 to operate the robot 30.

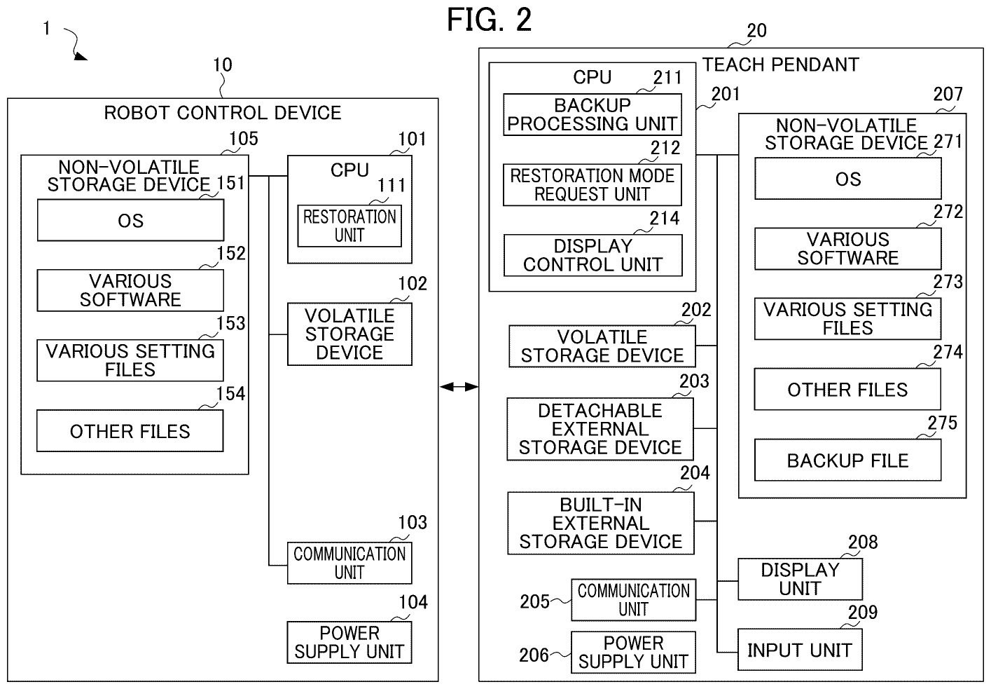

FIG. 2 is a functional block diagram illustrating a functional configuration example of the robot control device 10 and the teach pendant 20 according to the first embodiment.

As illustrated in FIG. 2, the robot control device 10 includes a CPU 101, a volatile storage device 102, a communication unit 103, a power supply unit 104, and a non-volatile storage device 105 serving as a storage unit.

The non-volatile storage device 105 is a solid-state drive (SSD), a hard disk drive (HDD) or the like, and stores an OS 151, various software 152, various setting files 153, and other files 154.

The OS 151 is, for example, an operating system (OS) or a system program that runs on the robot control device 10.

The various software 152, for example, stores software such as the motion programs of the robot 30 and application programs which implement various functions of the robot control device 10.

The various setting files 153, for example, store setting files for the software stored in the various software 152, and setting files for network communication of the communication unit 103 (described later).

The other files 154, for example, store log data on the operation of the robot control device 10 and the robot 30.

The CPU 101 is a processor that controls the entire robot control device 10. The CPU 101 reads the system program of the OS 151 and the application programs of the various software 152 stored in the non-volatile storage device 105 via a bus, and controls the entire robot control device 10 in accordance with the system program and the application programs. As a result, as illustrated in FIG. 2, the CPU 101 is configured to implement the function of the restoration unit 111.

The restoration unit 111 uses the backup file received from the teach pendant 20 (described later) to restore the state of the software of the robot control device 10 to the state when the backup file was saved.

The volatile storage device 102 is, for example, random access memory (RAM) or the like, loads various files stored in the non-volatile storage device 105 as needed, and is used for calculation processing, etc. by the CPU 101.

The communication unit 103, for example, controls data transmission and reception between the teach pendant 20 (described later) and the robot 30. The communication unit 103 may control network communication with other devices via a network (not illustrated) including the Internet.

When a request to send a backup file is received from the teach pendant 20, based on the control command from the CPU 101, the communication unit 103 may send the backup file of all or part of the files of the OS 151, the various software 152, the various setting files 153, and the other files 154 stored in the non-volatile storage device 105, to the teach pendant 20. When a request to transition to the restoration mode is received from the teach pendant 20, based on the control command from the CPU 101, the communication unit 103 may receive a backup file from the teach pendant 20.

The power supply unit 104, for example, supplies power to the robot control device 10. Note that the power supply unit 104 may supply power to the teach pendant 20 (described later) in a wired or wireless manner.

### <Teach Pendant 20>

The teach pendant 20 is a device that teaches the robot 30, and may be a computer specifically designed for the robot control device 10, or may be a computer such as a tablet computer.

As illustrated in FIG. 2, the teach pendant 20 includes a CPU 201, a volatile storage device 202, a communication unit 205, a power supply unit 206, a non-volatile storage device 207, a display unit 208, and an input unit 209. The CPU 201 includes a backup processing unit 210, a restoration mode request unit 211, and a display control unit 212.

The non-volatile storage device 207 is a ROM (read only memory), an SSD, an HDD, or the like, and stores an OS 271, various software 272, various setting files 273, other files 274, and a backup file 275.

The OS 271, for example, stores the operating system (OS) or the system program that runs on the teach pendant 20.

The various software 272, for example, stores software such as application programs that implement various functions of the teach pendant 20.

The various setting files 273, for example, store setting files for software stored in the various software 272, and setting files for communications of the communication unit 205 (described later).

The other files 274, for example, store log data on the operation history of the operator on the teach pendant 20.

The backup file 275 stores backup files of all or part of the OS 151, the various software 152, the various setting files 153, and the other files 154 stored in the non-volatile storage device 105 of the robot control device 10.

The backup file 275, for example, may be stored in different storage locations, depending on the date and time of backup.

The CPU 201 is a processor that totally controls the teach pendant 20. The CPU 201 reads the system program of the OS 271 stored in the non-volatile storage device 207 and the application programs stored in the various software 272 via a bus, and controls the entire teach pendant 20 in accordance with the system program and the application programs. In this manner, as illustrated in FIG. 2, the CPU 201 is configured to implement the functions of the backup processing unit 210, the restoration mode request unit 211, and the display control unit 212.

For example, when the input unit 209 receives a command to start saving the backup file 275, based on the input operation of the operator as a user, the backup processing unit 210 requests the robot control device 10 to download the backup file to the teach pendant 20, in order to save the backup file on the teach pendant 20.

For example, when the input unit 209 (described later) receives a command for restoration from the backup file 275, based on the input operation of the operator as a user, the restoration mode request unit 211 requests the robot control device 10 to transition to the restoration mode via the communication unit 205. Then, when a request to transition to the restoration mode is received from the teach pendant 20, the robot control device 10 restores the state of the software using the backup file received from the teach pendant 20.

For example, when the input unit 209 (described later) receives a command for restoration from the backup file 275, based on the input operation of the operator, the display control unit 212 displays a display screen on the display unit 208 (described later), asking the operator to input the storage location of the backup file.

Specifically, for example, when receiving a command for restoration from the backup file 275, and a plurality of backup files 275 are located in different storage locations, the display control unit 212 displays a display screen on the display unit 208, asking the operator to input the storage locations of the backup files. The operator inputs the storage locations of the backup files 275 for restoration, via the input unit 209.

Note that the display control unit 212 may display the date and time when the backup files 275 were each created.

The volatile storage device 202, for example, is RAM or the like, loads various files stored in the non-volatile storage device 207 as needed, and is used for calculation processing, etc. by the CPU 201.

In the present embodiment, the example has been described in which the backup file 275 is stored in the non-volatile storage device 207; however, the foregoing is not intended to be limiting. For example, the teach pendant 20 may include a detachable external storage device 203 or a built-in external storage device 204, and store the backup file 275 in the detachable external storage device 203 or the built-in external storage device 204.

Here, the detachable external storage device 203 is, for example, a storage device such as a USB memory, which is relatively easy to attach and detach, since the connection terminal thereof is located outside the housing of the teach pendant 20.

The built-in external storage device 204 is, for example, a storage device such as a microSD card, which is relatively difficult to attach and detach, since the connection terminal is located on the electronic board inside the housing of the teach pendant 20. Note that standards for the built-in external storage device 204 include, for example, eSD (embedded SD), etc.

The communication unit 205, for example, controls data transmission and reception to and from the robot control device 10. The communication unit 205 may control network communication with other devices via a network (not illustrated) including the Internet.

When the communication unit 205 requests the robot control device 10 to transition to the restoration mode, based on the control command from the CPU 201, and the storage location of the backup file is inputted, the communication unit 205 may send the backup file 275 stored in the non-volatile storage device 207 to the teach pendant 20.

The power supply unit 206, for example, supplies power to the teach pendant 20. The power supply unit 206 may receive power from the robot control device 10 in a wired or wireless manner.

The display unit 208 is a display device such as an LCD (liquid crystal display), and displays a display screen, asking for an input of the storage location of the backup file, based on the display command from the display control unit 212.

The input unit 209, for example, is a keyboard or touch panel arranged on the display unit 208, and receives an input from the operator.

### <Backup Processing of Robot System 1>

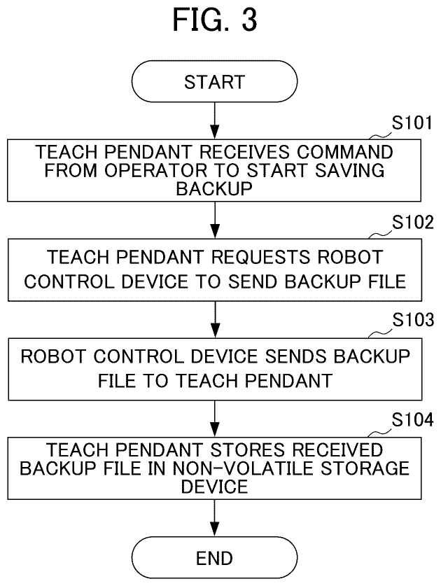

Next, referring to FIG. 3, the flow of the backup processing of the robot system 1 will be described.

FIG. 3 is a flowchart illustrating the backup processing of the robot system 1. The flow illustrated here is executed each time the teach pendant 20 receives a command from the operator to start saving a backup.

In Step S101, the teach pendant 20 (input unit 209) receives a command from the operator to start saving a backup of the robot control device 10.

In Step S102, based on the command to start saving a backup received in Step S101, the teach pendant 20 (backup processing unit 210) requests the robot control device 10 to send a backup file.

In Step S103, when the robot control device 10 (communication unit 103) receives a request to send a backup file from the teach pendant 20 (backup processing unit 210) in Step S102, the robot control device 10 sends a backup file to the teach pendant 20, based on the control command of the CPU 101. Note that the backup file may be one or more files saved in the non-volatile storage device 105 in the robot control device 10, or may be a disk image file in the robot control device 10.

In Step S104, the teach pendant 20 (backup processing unit 210) stores the received backup file in the non-volatile storage device 207. As described above, the teach pendant 20 (CPU 201) may store the received backup file in the detachable external storage device 203 or the built-in external storage device 204, instead of the non-volatile storage device 207.

### <Restoration Processing of Robot System 1>

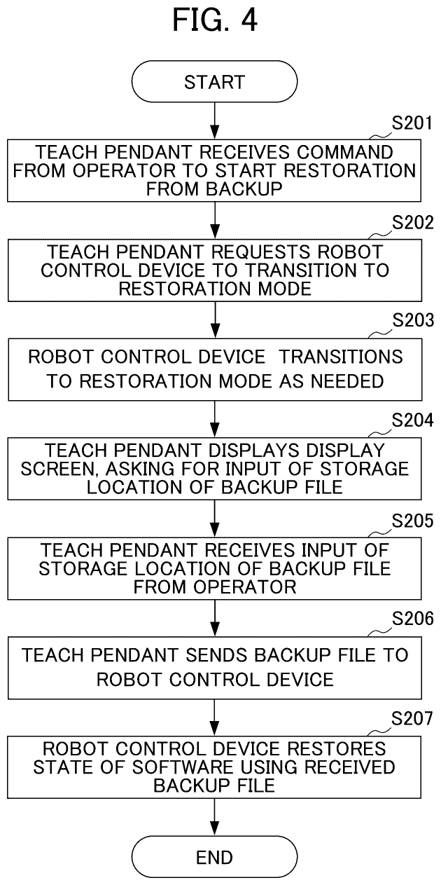

Next, referring to FIG. 4, the flow of the restoration processing of the robot system 1 will be described.

FIG. 4 is a flowchart illustrating the restoration processing of the robot system 1. The flow illustrated here is executed each time the teach pendant 20 receives a command from the operator to start restoration from the backup.

In Step S201, the teach pendant 20 (the input unit 209) receives a command from the operator to start restoration from the backup of the robot control device 10.

In Step S202, the teach pendant 20 (restoration mode request unit 211) requests the robot control device 10 to transition to the restoration mode.

In Step S203, the robot control device 10 (restoration unit 111) transitions to the restoration mode.

In Step S204, if there are a plurality of backup files 275, the teach pendant 20 (display control unit 212) displays a display screen, asking the operator to input the storage locations of the backup files 275.

In Step S205, the teach pendant 20 (input unit 209) receives the input of the storage location of the backup file 275 from the operator, on the display screen displayed in Step S204. At this time, the teach pendant 20 may display the date and time when the backup file was created.

In Step S206, the teach pendant 20 (communication unit 205) sends the backup file 275 stored in the storage location as received in Step S205 to the robot control device 10.

In Step S207, the robot control device 10 (restoration unit 111) restores the state of the software using the received backup file 275.

In this manner, the teach pendant 20 according to the first embodiment introduces a large-capacity storage device to save the backup file of the robot control device, and can easily manage the backup files, ensuring the restoration of the state of the software of the robot control device in the event of loss of programs, data, etc. due to failures or incorrect operations of the robot control device.

The non-volatile storage device 207 of the teach pendant 20 can save the backup file of the robot control device 10 connected to the teach pendant 20. As a result, since the teach pendant 20 is purchased and used together with the robot control device 10 in many cases, the effect of requiring no additional monetary cost for saving the backup files can be achieved.

In many cases, the robot control device 10 and the teach pendant 20 are integrally operated as a pair. Therefore, by saving the backup file in the teach pendant 20, the backup file can be easily recognized as the backup file of the corresponding robot control device 10. Further, in many cases, the robot control device 10 and the teach pendant 20 are physically connected; therefore, the possibility of losing the teach pendant 20 is low.

The first embodiment has been described above.

### Second Embodiment

Next, the second embodiment will be described. As described above, when saving a backup file, the teach pendant 20 of the first embodiment is connected to one robot control device 10, saves only the backup file of the robot control device 10, and restores the state of the software of the robot control device 10 by using the saved backup file. In contrast, the teach pendant 20A of the second embodiment can be connected to a plurality of robot control devices 10A, saves backup files including the individual numbers of the robot control devices 10A, respectively, and uses a backup file corresponding to an individual number of a connected robot control device 10A to restore the state of the software of the connected robot control device 10A, which differs from the first embodiment.

As a result, the teach pendant 20A introduces a large-capacity storage device to save the backup files of the robot control devices, and can easily manage the backup files, ensuring the restoration of the state of the software of the robot control devices in the event of loss of programs, data, etc. due to failures or incorrect operations of the robot control devices. The teach pendant 20A can prevent the restoration of the robot control device 10A from a backup file of another robot control device 10A.

The second embodiment will be described below.

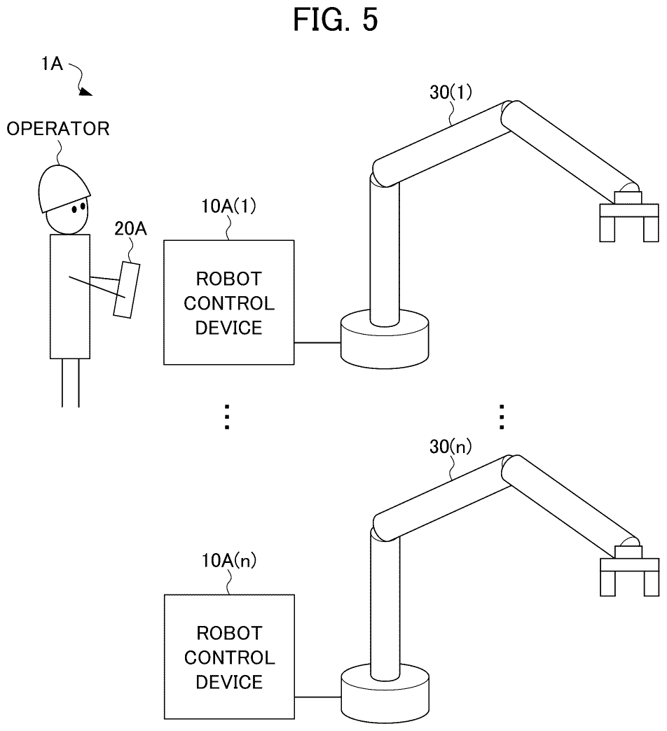

FIG. 5 is a diagram illustrating a configuration example of a robot system according to the second embodiment. Here, an example is illustrated, in which one teach pendant is used for a plurality of robot control devices. Note that the present invention is also applicable to the case where two or more teach pendants are used.

As illustrated in FIG. 5, the robot system 1A has n robot control devices 10A (1) 10A (n), one teach pendant 20A, and n robots 30(1)-30 (n) (n is an integer equal to or greater than 2).

The robot control devices 10A (1)-10A (n) and the robots 30(1)˜30 (n) may be directly connected to each other via a connection interface (not illustrated) in a wired or wireless manner. The robot control devices 10A (1)˜10A (n) and the robots 30(1)-30 (n) may be connected to each other via a network (not illustrated) such as LAN (local area network) or the Internet in a wired or wireless manner. In this case, the robot control devices 10A (1)˜10A (n) and the robots 30(1)˜30 (n) include a communication unit (not illustrated) to communicate with each other via such connection.

On the other hand, the teach pendant 20A may be directly connected to any one of the robot control devices 10A (1) 10A (n) via a connection interface (not illustrated) in a wired or wireless manner. The teach pendant 20A may be connected to any one of the robot control devices 10A (1) 10A (n) via a network (not illustrated) such as LAN or the Internet in a wired or wireless manner. In this case, the teach pendant 20A includes a communication unit (not illustrated) to communicate with each other via such connection.

Hereafter, when there is no need to individually distinguish the robot control devices 10A (1)-10A (n), they are collectively referred to as the “robot control device 10A”. Similarly, when there is no need to individually distinguish the robots 30(1) 30 (n), they are collectively referred to as the “robot 30”.

### <Robot 30>

The robot 30 according to the second embodiment is the same as that of the first embodiment, and the detailed description thereof is omitted.

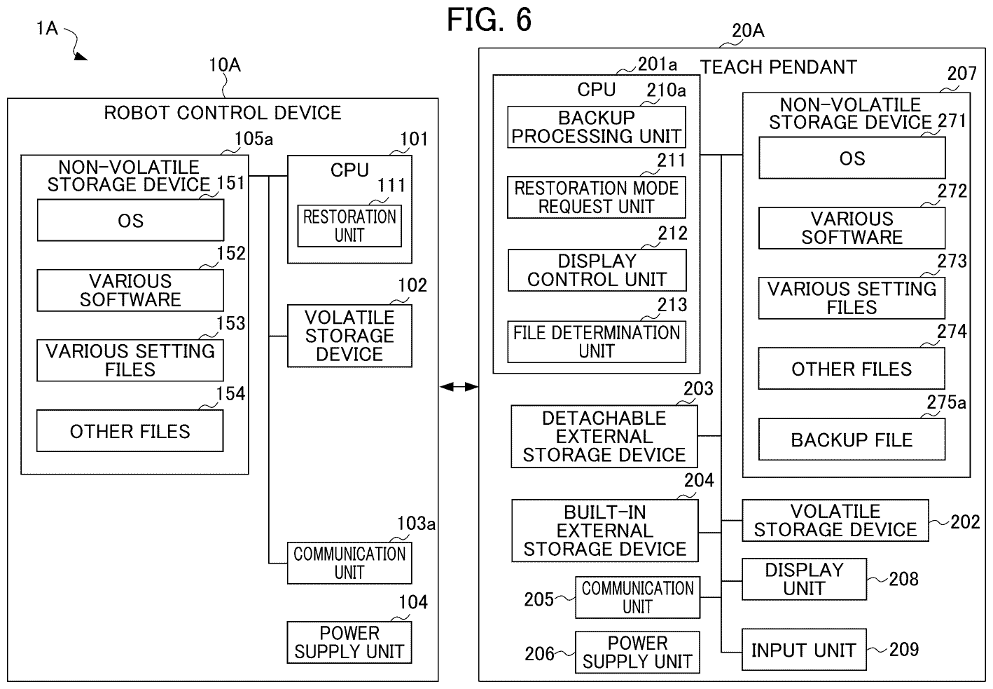

FIG. 6 is a functional block diagram illustrating a functional configuration example of the robot control device 10A and the teach pendant 20A according to the second embodiment. Note that the same reference numerals are assigned to elements having the same functions as those of the robot control device 10 and the teach pendant 20 in FIG. 2, and the detailed description thereof is omitted.

### <Robot Control Device 10A>

The robot control device 10A according to the second embodiment has the configuration equivalent to that of the robot control device 10 according to the first embodiment.

That is, as illustrated in FIG. 6, the robot control device 10A includes the CPU 101, the volatile storage device 102, a communication unit 103a, the power supply unit 104, and a non-volatile storage device 105a. The CPU 101 includes the restoration unit 111. The non-volatile storage device 105a stores the OS 151, the various software 152, the various setting files 153, and the other files 154.

The CPU 101, the volatile storage device 102, and the power supply unit 104 have the functions equivalent to those of the CPU 101, the volatile storage device 102, and the power supply unit 104 in the first embodiment.

The restoration unit 111 has the function equivalent to that of the restoration unit 111 in the first embodiment.

The OS 151, the various software 152, the various setting files 153, and the other files 154 are the data equivalent to the OS 151, the various software 152, the various setting files 153, and the other files 154 in the first embodiment.

The non-volatile storage device 105a stores electronic information indicating an individual number assigned in advance to the robot control device 10A when manufactured. Note that the individual number is guaranteed to be a number unique to each robot control device 10A when manufactured. The individual number may be a character string, or a combination of numbers and characters.

The communication unit 103a controls data transmission and reception between the teach pendant 20A and the robot 30, as in the case of the communication unit 103 of the first embodiment. The communication unit 103a may control network communication with other devices via a network (not illustrated) including the Internet.

When a request to send a backup file is received from the teach pendant 20A, based on the control command of the CPU 101, the communication unit 103a may send the backup file that includes information indicating the individual number of the robot control device 10A, along with all or part of the files stored in the non-volatile storage device 105, such as the OS 151, the various software 152, the various setting files 153, and the other files 154, to the teach pendant 20. When a request to send the individual number of the robot control device 10A is received from the teach pendant 20A, based on the control command of the CPU 101, the communication unit 103a may send the individual number of the robot control device 10A to the teach pendant 20A.

### <Teaching Pendant 20A>

The teach pendant 20A according to the second embodiment has the configuration equivalent to that of the teach pendant 20 according to the first embodiment.

That is, as illustrated in FIG. 6, the teach pendant 20A includes a CPU 201a, the volatile storage device 202, the detachable external storage device 203, the built-in external storage device 204, the communication unit 205, the power supply unit 206, the non-volatile storage device 207, the display unit 208, and the input unit 209. The CPU 201a includes a backup processing unit 210a, the restoration mode request unit 211, the display control unit 212, and a file determination unit 213. The non-volatile storage device 207 stores the OS 271, the various software 272, the various setting files 273, the other files 274, and a backup file 275a.

The volatile storage device 202, the detachable external storage device 203, the built-in external storage device 204, the communication unit 205, the power supply unit 206, the non-volatile storage device 207, the display unit 208, and the input unit 209 have the functions equivalent to those of the volatile storage device 202, the detachable external storage device 203, the built-in external storage device 204, the communication unit 205, the power supply unit 206, the non-volatile storage device 207, the display unit 208, and the input unit 209 in the first embodiment.

The restoration mode request unit 211 and the display control unit 212 have the functions equivalent to those of the restoration mode request unit 211 and the display control unit 212 in the first embodiment.

The OS 271, the various software 272, the various setting files 273, and the other files 274 are the data equivalent to the OS 271, the various software 272, the various setting files 273, and the other files 274 in the first embodiment.

The backup file 275a stores a backup file that includes information indicating the individual number of the robot control device 10A, along with all or part of the files stored in the non-volatile storage device 105a of the robot control device 10A, such as the OS 151, the various software 152, the various setting files 153, and the other files 154.

The CPU 201a is a processor that totally controls the teach pendant 20A. The CPU 201a reads the system program of the OS 271 stored in the non-volatile storage device 207, and the application programs stored in the various software 272, via a bus, and controls the entire teach pendant 20A in accordance with the system program and the application programs. As a result, as illustrated in FIG. 6, the CPU 201a is configured to implement the functions of the backup processing unit 210a, the restoration mode request unit 211, the display control unit 212, and the file determination unit 213.

For example, when the input unit 209 receives a command to start saving the backup file 275a, based on the input operation of the operator, the backup processing unit 210a requests the robot control device 10A to download the backup file to the teach pendant 20, in order to save the backup file including the information indicating the individual number of the robot control device 10A on the teach pendant 20.

For example, when the input unit 209 receives a command from the operator for restoration from the backup file, the file determination unit 213 receives the individual number of the connected robot control device 10A from the robot control device 10A, and determines whether the received individual number matches the individual number included in the backup file 275a located in the inputted storage location.

If the received individual number matches the individual number included in the backup file 275a, the file determination unit 213 sends the backup file 275a located in the inputted storage location to the robot control device 10A.

On the other hand, if the received individual number does not match the individual number included in the backup file 275a, the display control unit 212 displays a display screen on the display unit 208, asking for a re-input of the storage location of the backup file 275a of the connected robot control device 10A.

In this manner, the teach pendant 20A can prevent the restoration of the connected robot control device 10A from a backup file 275a of another robot control device 10A.

### <Backup Processing of Robot System 1>

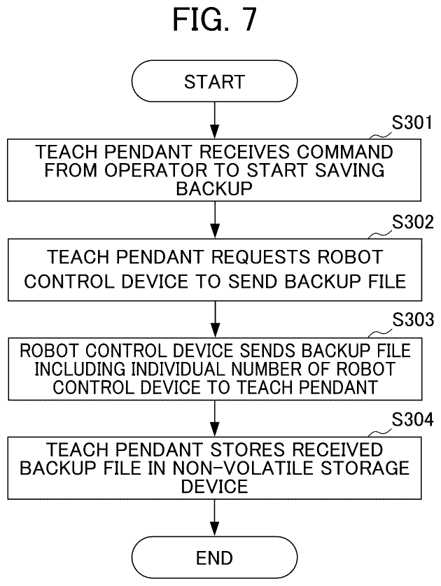

Next, referring to FIG. 7, the flow of backup processing of the robot system 1 will be described.

FIG. 7 is a flowchart illustrating the backup processing of the robot system 1. The flow illustrated here is executed each time the teach pendant 20A receives a command from the operator to start saving a backup.

Note that the processing in Steps S301, S302 and S304 is the same as the processing in Steps S101, S102 and 3104 of the first embodiment illustrated in FIG. 3, and the description thereof is omitted.

In Step S303, in the case of receiving the request in Step S302, the robot control device 10A (communication unit 103a) sends a backup file including information indicating the individual number of the robot control device 10A to the teach pendant 20A.

### <Restoration Processing of Robot System 1>

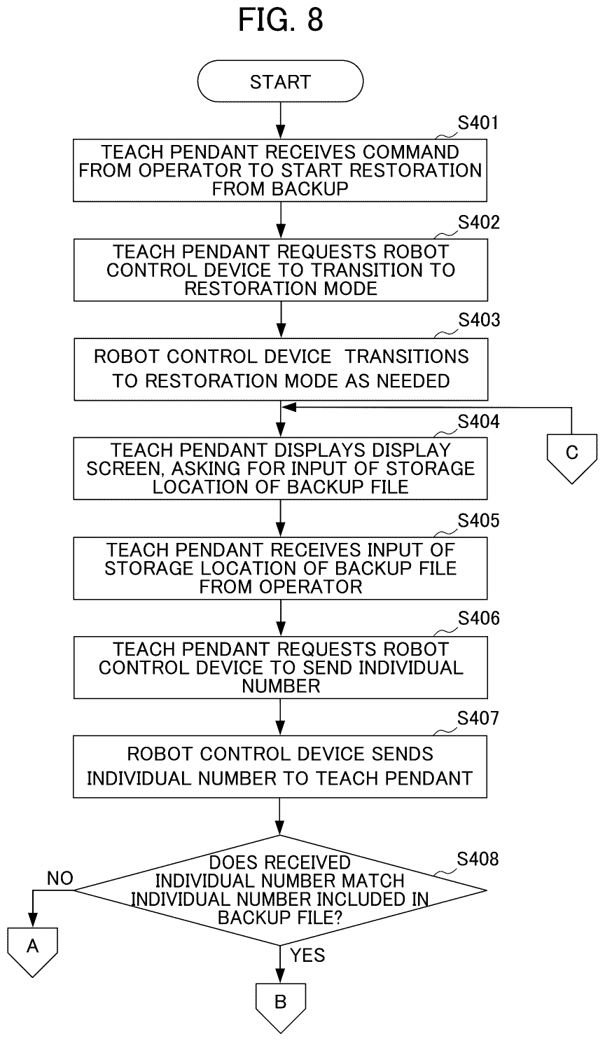

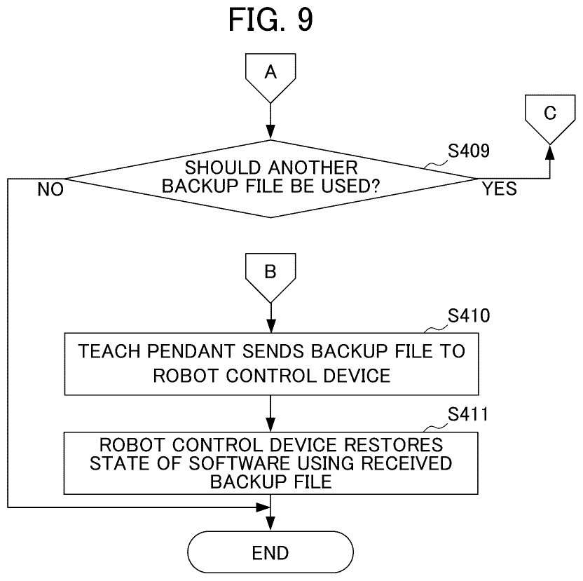

Next, referring to FIGS. 8 and 9, the flow of restoration processing of the robot system 1 will be described.

FIGS. 8 and 9 are flowcharts illustrating the restoration processing of the robot system 1. The flow illustrated here is executed each time the teach pendant 20A receives a command from the operator to start restoration from the backup.

Note that the processing in Steps 3401 to S405, S410 and S411 are the same as the processing in Step S201 to S205, 3206 and S207 of the first embodiment illustrated in FIG. 4, and the description thereof is omitted.

In Step S406, the teach pendant 20A (file determination unit 213) requests the connected robot control device 10A to send the individual number.

In Step S407, the robot control device 10A (communication unit 103a) sends the individual number to the teach pendant 20A.

In Step S408, the teach pendant 20A (file determination unit 213) determines whether the received individual number matches the individual number included in the backup file located in the storage location inputted in Step S405. If the received individual number matches the individual number included in the backup file, the processing proceeds to Step S410 in FIG. 9. On the other hand, if the received individual number does not match the individual number included in the backup file, the processing proceeds to Step S409.

In Step S409, the teach pendant 20A (file determination unit 213) causes the display unit 208 to display a message indicating that the individual numbers do not match, and a message asking whether another backup file should be used. If the input unit 209 receives an answer from the operator to use another backup file, the processing returns to Step S404 in FIG. 3. On the other hand, if the input unit 209 receives an answer from the operator not to use another backup file, the restoration processing ends.

As described above, the teach pendant 20A according to the second embodiment introduces a large-capacity storage device to save the backup files of the plurality of robot control devices, and can easily manage the backup files, ensuring the restoration of the state of the software of the robot control devices in the event of loss of programs, data, etc. due to failures or incorrect operations of the robot control devices.

The teach pendant 20A receives and stores a backup file that includes the individual number of the robot control device 10A(i) from the robot control device 10A(i), and when restoring the state of the software of the robot control device 10A(i), the teach pendant 20A receives the individual number from the robot control device 10A(i), and compares the received individual number with the individual number included in the backup file, whereby the teach pendant 20A can prevent the restoration of the robot control device 10A(i)a from a backup file of another robot control device 10A(j). Note that i, j are integers from 1 to n, where i is not equal to j.

Thus, the teach pendant 20A achieves the effect of being able to reduce the management cost for the backup files of the plurality of robot control devices 10A.

The second embodiment has been described above.

### Third Embodiment

Next, the third embodiment will be described. As described above, in the first embodiment, when storing the backup files, the teach pendant 20 is connected to one robot control device 10, saves only the backup file of the robot control device 10, and uses the saved backup file to restore the state of the software of the robot control device 10. In the second embodiment, the teach pendant 20A can be connected to a plurality of robot control devices 10A, stores the backup files including the individual numbers of the robot control devices 10A, respectively, and uses a backup file corresponding to an individual number of a connected robot control device 10A to restore the state of the software of the connected robot control device 10A. In contrast, in the third embodiment, a function to display a preview of a backup file is added to the first and second embodiments, when the teach pendant 20B restores the state of the software of the robot control device 10 from the backup file.

As a result, the teach pendant 20B introduces a large-capacity storage device to save the backup files of the robot control devices, and can easily manage the backup files, ensuring the restoration of the state of the software of the robot control devices in the event of loss of programs, data, etc. due to failures or incorrect operations of the robot control devices. The teach pendant 20B displays a preview of the backup file immediately before the restoration operation of the backup file, thereby allowing for preventing the restoration from unintended backup files.

The third embodiment will be described below.

The robot system 1 according to the third embodiment is the same as the robot system 1 in FIG. 1. Here, an example is illustrated, in which the function of displaying a preview of the backup file immediately before the restoration operation of the backup file is applied to the teach pendant according to the first embodiment. Note that the present invention is also applicable to the teach pendant according to the second embodiment.

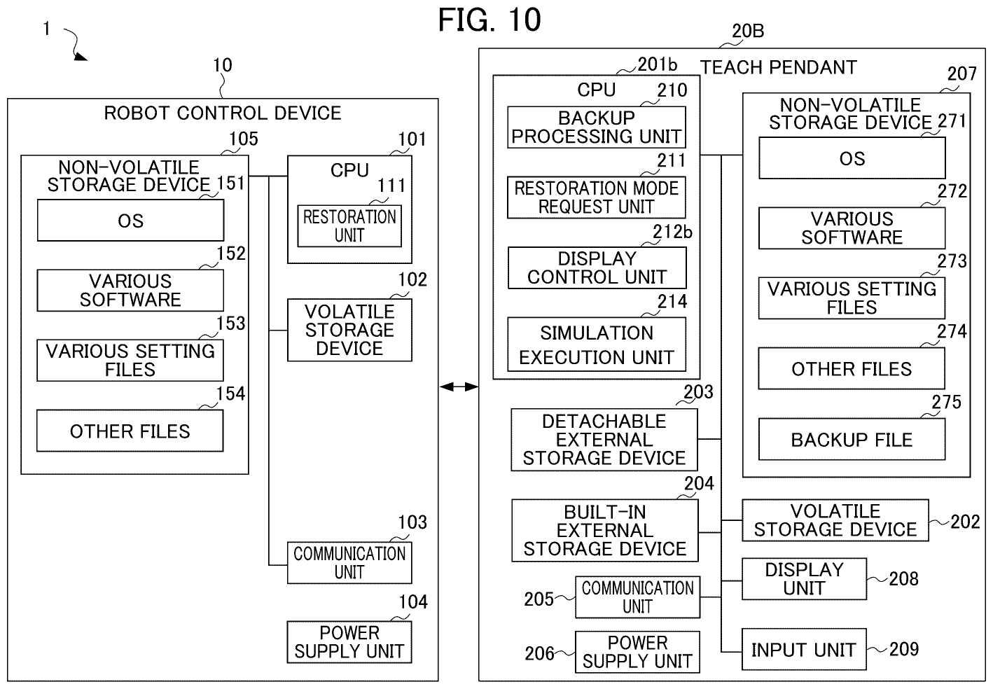

FIG. 10 is a functional block diagram illustrating a functional configuration example of the robot control device 10 and the teach pendant 20B according to the third embodiment. Note that the same reference numerals are assigned to elements having the same functions as those of the robot control device 10 and the teach pendant 20 in FIG. 2, and the detailed description thereof is omitted.

### <Robot Control Device 10>

The robot control device 10 according to the third embodiment is the same as that in the first or second embodiment.

### <Teaching Pendant 20B>

The teach pendant 20B according to the third embodiment has the structure equivalent to that of the teach pendant 20 in the first embodiment.

That is, as illustrated in FIG. 8, the teach pendant 20B includes a CPU 201b, the volatile storage device 202, the detachable external storage device 203, the built-in external storage device 204, the communication unit 205, the power supply unit 206, the non-volatile storage device 207, the display unit 208, and the input unit 209. The CPU 201b includes the backup processing unit 210, the restoration mode request unit 211, a display control unit 212b, and a simulation execution unit 214. The non-volatile storage device 207 stores the OS 271, the various software 272, the various setting files 273, the other files 274, and the backup files 275.

The volatile storage device 202, the detachable external storage device 203, the built-in external storage device 204, communication unit 205, the power supply unit 206, the non-volatile storage device 207, the display unit 208, and the input unit 209 have the functions equivalent to those of the volatile storage device 202, the detachable external storage device 203, the built-in external storage device 204, the communication unit 205, the power supply unit 206, the non-volatile storage device 207, the display unit 208, and the input unit 209 in the first embodiment.

The backup processing unit 210 and the restoration mode request unit 211 have the functions equivalent to those of the backup processing unit 210 and the restoration mode request unit 211 in the first embodiment.

The OS 271, the various software 272, the various setting files 273, the other files 274, and the backup files 275 are the data equivalent to the OS 271, the various software 272, the various setting files 273, the other files 274, and the backup files 275 in the first embodiment.

As in the case of the second embodiment, the teach pendant 20B includes the CPU 201b, the volatile storage device 202, the detachable external storage device 203, the built-in external storage device 204, the communication unit 205, the power supply unit 206, the non-volatile storage device 207, the display unit 208, and the input unit 209. The CPU 201b includes the backup processing unit 210a, the restoration mode request unit 211, the display control unit 212b, the file determination unit 213, and the simulation execution unit 214.

The non-volatile storage device 207 stores the OS 271, the various software 272, the various setting files 273, the other files 274, and the backup files 275a.

The CPU 201b is a processor that totally controls the teach pendant 20B. The CPU 201b reads the system program of the OS 271 stored in the non-volatile storage device 207, and the application program stored in the various software 272 via the bus, and controls the entire teach pendant 20B in accordance with the system program and the application program. As a result, as illustrated in FIG. 8, the CPU 201b is configured to implement the functions of the backup processing unit 210, the restoration mode request unit 211, the display control unit 212b, and the simulation execution unit 214.

When the input unit 209 receives a command for restoration from the backup file 275, based on the input operation of the operator, the display control unit 212b displays a display screen on the display unit 208, asking the operator to input the storage location of the backup file, and causes the display unit 208 to display a preview of the case of restoring the robot control device 10 from the backup file located in the inputted storage location, before starting the restoration.

Specifically, for example, when the input unit 209 receives a command to preview the backup file 275, based on the input operation of the operator, the display control unit 212b may display the content of the motion program of the robot 30 included in the backup file 275, in a text file format on the display unit 208. The display control unit 212b may also display the network settings of the communication unit 205 on the display unit 208. For example, the display control unit 212b may cause the display unit 208 to display how the 3D model of the robot 30 operates in accordance with the motion program of the robot 30 in the case where the simulation execution unit 214 executes the simulator software for the robot stored in the various software 272, and applies the backup file 275 on the simulator software.

Thus, the teach pendant 20B can prevent the restoration from unintended backup files.

The simulation execution unit 214 simulates at least one operation of the robot control device 10, the robot 30, or a peripheral device (not illustrated) of the robot 30 in the case of restoring the robot control device 10 from the backup file 275 located in the inputted storage location.

Specifically, for example, the simulation execution unit 214 uses a known simulation method to execute the motion program of the robot 30 included in the backup file 275 located in the inputted storage location, thereby simulating the operation of the robot control device 10, the robot 30, or the peripheral device (not illustrated) of the robot 30 arranged in a 3D virtual space.

Then, the display control unit 212b may display a preview of an execution result of the simulation execution unit 214, in which the 3D model of the robot control device 10, the robot 30, or the peripheral device (not illustrated) of the robot 30 is arranged in a virtual space.

### <Restoration Processing of Robot System 1>

The backup processing of the robot system 1 according to the third embodiment is the same as that of the first embodiment illustrated in FIG. 3 or the second embodiment illustrated in FIG. 7, and the detailed description thereof is omitted.

### <Restoration Processing of Robot System 1>

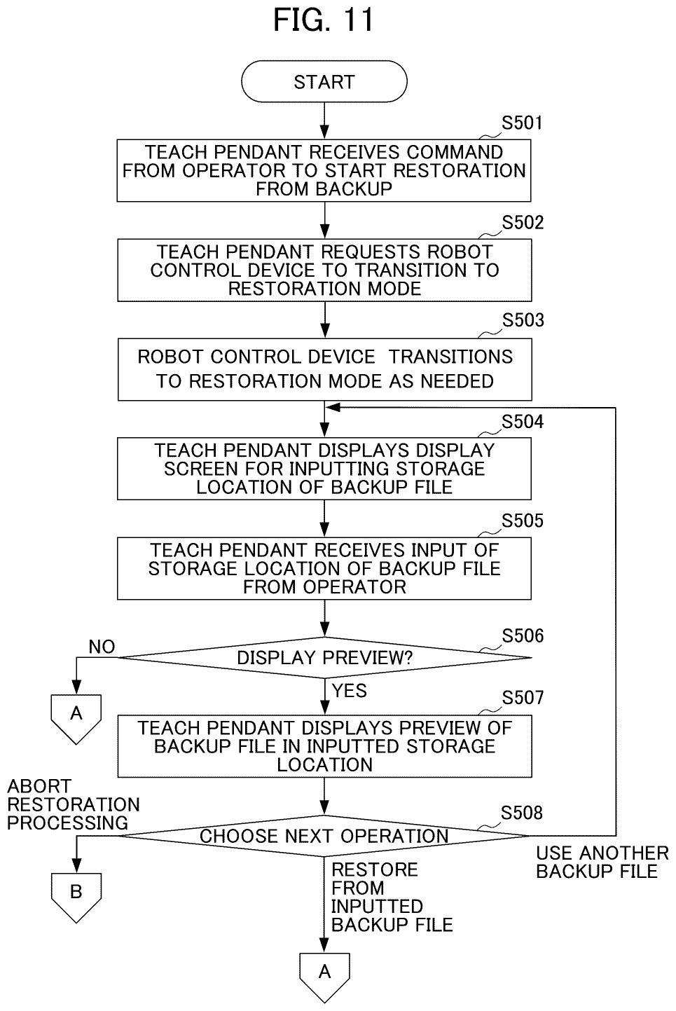

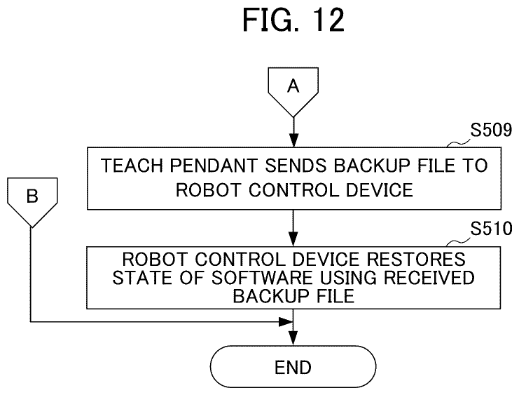

Next, referring to FIGS. 11 and 12, the flow of the restoration processing of the robot system 1 will be described.

FIGS. 11 and 12 are flowcharts illustrating the restoration processing of the robot system 1. The flow illustrated here is executed each time the teach pendant 20B receives a command from the operator to start restoration from the backup.

Note that the processing in Steps S501 to S505, S509 and S510 are the same as the processing in Steps S201 to S205, S206 and S207 in the first embodiment illustrated in FIG. 4, and the description thereof is omitted.

In Step S406, the teach pendant 20B (display control unit 212b) displays a display screen, asking whether to display a preview of the case of restoring the robot control device 10 from the backup file located in the storage location inputted in Step S505. If a command to display a preview is received via the input unit 209, the processing proceeds to Step S507. On the other hand, if a command not to display a preview is received via the input unit 209, the processing proceeds to Step S509 in FIG. 12.

In Step S507, the teach pendant 20B (display control unit 212b) displays a preview of the backup file located in the storage location inputted in Step S505.

In Step S508, the teach pendant 20B (display control unit 212b) displays a display screen on the display unit 208, allowing the operator to choose the next operation. If the input unit 209 receives a choice to use the inputted backup file 275 for restoration as the next operation, the processing proceeds to Step S509 in FIG. 12. If the input unit 209 receives a choice to use another backup file as the next operation, the processing returns to Step S504. If the input unit 209 receives a choice to abort the restoration processing as the next operation, the restoration processing ends.

Thus, as in the case of the first or second embodiment, the teach pendant 20B according to the third embodiment introduces a large-capacity storage device to save the backup files of the robot control devices, and can easily manage the backup files, ensuring the restoration of the state of the software of the robot control devices in the event of loss of programs, data, etc. due to failures or incorrect operations of the robot control devices.

The teach pendant 20B displays a preview of the backup file immediately before the restoration operation, thereby allowing for preventing the restoration from unintended backup files.

The non-volatile storage device 207 of the teach pendant 20B can save the backup files of the robot control device 10 connected to the teach pendant 20B. As a result, since the teach pendant 20B is purchased and used together with the robot control device 10 in many cases, the effect of requiring no additional monetary cost for saving the backup files can be achieved.

In many cases, the robot control device 10 and the teach pendant 20B are integrally operated as a pair. Therefore, by saving the backup file on the teach pendant 20B, the backup file can be easily recognized as the backup file of the corresponding robot control device 10. Further, in many cases, the robot control device 10 and the teach pendant. 20B are physically connected; therefore, the possibility of losing the teach pendant 20B is low.

The third embodiment has been described above.

The first, second, and third embodiments have been described above; however, the robot control devices 10, 10A and the teach pendants 20, 20A, 20B are not limited to the above embodiments, and include modifications and improvements within the scope that can achieve the objectives.

### Modification Example 1

In the first and third embodiments, the teach pendants 20, 20B display a display screen for the operator to input the storage location of the backup file 275 in the case of having a plurality of backup files 275, and receive an input of the storage location of the backup file 275 from the operator; however, the foregoing is not intended to be limiting.

For example, instead of the operator inputting the storage location, the teach pendants 20, 20B may automatically select a backup file having the most recent acquisition date and time, and send it to the robot control device 10.

### Modification Example 2

For example, in the second embodiment, the teach pendant 20A acquires the individual number of the connected robot control device 10A by requesting the connected robot control device 10A to send the individual number; however, the foregoing is not intended to be limiting. For example, the individual number may be sent or received upon connecting the robot control device 10A and the teach pendant 20A, or when turning on the power, etc.

Note that the functions included in the robot control devices 10, 10A and the teach pendants 20, 20A, 20B according to the first, second, and third embodiments can be implemented by hardware, software, or a combination thereof. Here, implementation by software means implementation by a computer reading and executing a program.

The program can be stored using various types of non-transitory computer-readable media, and can be supplied to a computer. The non-transitory computer-readable media include various types of tangible storage media. Examples of the non-transitory computer-readable media include magnetic recording media (such as flexible disks, magnetic tapes, hard disk drives), magneto-optical recording media (such as magneto-optical disks), CD-ROM (read only memory), CD-R, CD-R/W, semiconductor memory (such as mask ROM, PROM (programmable ROM), EPROM (erasable PROM), flash ROM, RAM). The program may be supplied to a computer by various types of transitory computer-readable media. Examples of the transitory computer-readable media include electrical signals, optical signals, and electromagnetic waves. The transitory computer-readable media can supply a program to a computer via wired communication paths such as electric wires and optical fibers, or via wireless communication paths.

Note that the steps describing a program recorded on a recording medium include not only processes executed in chronological order, but also processes executed in parallel or individually, not necessarily in chronological order.

In other words, the teach pendant, the robot system, and the robot control device of the present disclosure can take various embodiments with the following configurations.

(1) The teach pendant 20 of the present disclosure includes: the communication unit 205 that receives a backup file of the robot control device 10 that controls the robot 30; and the non-volatile storage device 207 that saves the received backup file 275.

The teach pendant 20 introduces a large-capacity storage device to save the backup file of the robot control device, and can easily manage the backup file, ensuring the restoration of the state of the software of the robot control devices in the event of loss of programs, data, etc. due to failures or incorrect operations of the robot control devices.

(2) The teach pendant 20 described in (1) further includes: the input unit 209; the restoration mode request unit 211 that requests the robot control device 10 to transition to the restoration mode when the input unit 209 receives a command from the user for restoration from the backup file 275; and the display control unit 212 that displays a display screen, asking the user to input the storage location of the backup file 275, on the display unit 208 included in the teach pendant 20, when the input unit 209 receives a command from the user for restoration from the backup file 275, in which the communication unit 205 may send the backup file 275 located in the inputted storage location to the robot control device 10.

Thus, since the teach pendant 20 is purchased and used together with the robot control device 10, the effect of requiring no additional monetary cost for saving the backup files can be achieved.

(3) in the teach pendant 20A described in (2), the backup file 275a includes information indicating the individual number of the robot control device 10A. The teach pendant 20A further includes a file determination unit 213 that receives the individual number of the connected robot control device 10A from the robot control device 10A when the input unit 209 receives a command from the user for restoration from the backup file 275a. The file determination unit 213 determines whether the received individual number matches the individual number in the backup file 275a located in the inputted storage location. The communication unit 205 may send the backup file 275a located in the inputted storage location to the robot control device 10A when the received individual number matches the individual number in the backup file 275a. When the file determination unit 213 determines that the individual numbers do not match, the display control unit 212 may display a display screen on the display unit 208, asking for a re-input of the storage location of the backup file 275a of the connected robot control device 10A.

Thus, the teach pendant 20A can prevent the restoration of the robot control device 10A from a backup file of another robot control device 10A.

(4) in the teach pendant 20B described in (2) or (3), the display control unit 212b may display a preview of the case of restoring the robot control device 10 from the backup file 275 located in the inputted storage location on the display unit 208 before starting the restoration when the input unit 209 receives a command from the user for restoration from the backup file 275.

Thus, the teach pendant 20B displays a preview of the backup file immediately before starting the restoration operation, thereby allowing for preventing the restoration from unintended backup files.

(5) in the teach pendant 20B described in (4), the display control unit 212b may cause the display unit 208 to display a preview of at least the motion program or a text file of setting file for the robot 30, which is stored in the non-volatile storage device 105 included in the robot control device 10.

Thus, the operator can check the content of the stored backup file.

(6) The teach pendant 20B described in (4) further includes the simulation execution unit 214 that simulates at least one operation of the robot control device 10, the robot 30, or the peripheral device of the robot 30 in the case of restoring the robot control device 10 from the backup file 275 located in the inputted storage location. The simulation execution unit 214 executes the simulation when the input unit 209 receives a command for preview. The display control unit 212b may cause the display unit 208 to display a preview of an execution result of the simulation execution unit 214 using a 3D model of the robot.

Thus, the operator can check the operation state in the case of restoring the state of the robot control, device 10 from the backup file.

(7) The robot system 1 of the present disclosure includes: the robot control device 10, 10A that controls the robot 30; and the teach pendant 20, 20A, 20B described in any one of (1) to (6).

Thus, the robot system 1 can achieve the same effects as described in (1) to (6).

(8) The robot control device 10, 10A of the present disclosure includes the teach pendant 20, 20A, 20B described in any one of (1) to (6).

Thus, the robot control device 10, 10A can achieve the same effects as described in (1) to (6).

(9) The robot control device 10, 10A as described in (8) may further include: the communication unit 103, 103a that receives the backup file 275, 275a sent from the teach pendant 20, 20A, 20B; and the restoration unit 111 that restores the state of the software of the robot control device 10, 10A to the state when the backup file 275, 275a was saved, using the received backup file 275, 275a.

Thus, the robot control device 10, 10A has the effect of reducing the management cost for the backup files as compared to the case of saving the backup files in the external storage device.

### EXPLANATION OF REFERENCE NUMERALS

1, 1a: robot system
10, 10a (1)-10a (n): robot control device
101, 201: CPU
111: restoration unit
105, 207: non-volatile storage device
151, 271: OS
152, 272: various software
153, 273: various setting files
154, 274: other files
20, 20a, 20b: teach pendant
210, 210a: backup processing unit
211: restoration mode request unit
212, 212b: display control unit
213: file determination unit
214: simulation execution unit
275, 275a: backup file
30, 30(1)˜30(n): robot

1. A teach pendant, comprising:
a communication unit configured to receive a backup file of a robot control device that controls a robot; and
a storage unit configured to save the backup file received.

2. The teach pendant according to claim 1, further comprising:
an input unit;
a restoration mode request unit configured to request the robot control device to transition to a restoration mode when the input unit receives a command from a user for restoration from the backup file; and
a display control unit configured to display a display screen on a display unit included in the teach pendant, asking the user to input a storage location of the backup file when the input unit receives a command from the user for restoration from the backup file,
wherein the communication unit sends the backup file located in the storage location inputted, to the robot control device.

3. The teach pendant according to claim 2,
wherein the backup file includes information indicating an individual number of the robot control device,
wherein the teach pendant further comprises a file determination unit configured to receive the individual number of the robot control device from the robot control device connected, and determine whether the individual number received matches an individual number included in the backup file located in the storage location inputted, when the input unit receives a command from the user for restoration from the backup file,
wherein the communication unit sends the backup file located in the storage location inputted, to the robot control device, when the individual number received matches the individual number included in the backup file, and
wherein the display control unit causes the display unit to display a display screen, asking for a re-input of a storage location of the backup file of the robot control device connected, when the file determination unit determines that the individual numbers do not match.

4. The teach pendant according to claim 2, wherein the display control unit causes the display unit to display a preview of a case of restoring the robot control device from the backup file located in the storage location inputted, before starting restoration, when the input unit receives a command from a user for restoration from the backup file.

5. The teach pendant according to claim 4, wherein the display control unit causes the display unit to display, as the preview, at least a motion program or a text file of a setting file of the robot, as stored in a storage device included in the robot control device.

6. The teach pendant according to claim 4, further comprising:
a simulation execution unit configured to simulate at least one operation of the robot control device, the robot, or a peripheral device of the robot in a case of restoring the robot control device from the backup file located in the storage location inputted,
wherein the simulation execution unit executes simulation when the input unit receives a command for the preview, and
wherein the display control unit causes the display unit to display, as the preview, an execution result of the simulation execution unit using a 3D model of the robot.

7. A robot system, comprising:
a robot control device that controls a robot; and
the teach pendant according to claim 1.

8. A robot control device, comprising the teach pendant according to claim 1.

9. The robot control device according to claim 8, comprising:
a communication unit configured to receive a backup file sent from the teach pendant; and
a restoration unit configured to use the backup file received to restore a state of software of the robot control device to a state when the backup file was saved.
